(19) United States
(12) Patent Application Publication
(10) Pub. No.: US 2007/0229924 A1
(43) Pub. Date: Oct. 4, 2007

(54) DISPLAY DEVICE USING SINGLE-PANEL DIFFRACTIVE LIGHT MODULATOR

(75) Inventors: Shyshkin Ihar, Suwon-si (KR); Sung Kyong Oh, Suwon-si (KR); Chun Gi Kim, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon-si (KR)

(21) Appl. No.: 11/693,627

(22) Filed: Mar. 29, 2007

(30) Foreign Application Priority Data
Mar. 30, 2006 (KR) 10-2006-0029012

(51) Int. Cl. H04N 1/46

(52) U.S. Cl. 358/509

(57) ABSTRACT

Disclosed herein is a display device using a single-panel diffractive light modulator. The display device includes a light source unit, a condensing unit, an illumination unit, a diffractive light modulator, a projection unit, and a filter unit.

### CROSS REFERENCE TO RELATED APPLICATION

This application claims the benefit of Korean Patent Application No. 10-2006-0029012, filed on Mar. 30, 2006, entitled “Display System Using One Panel Optical Modulator”, which is hereby incorporated by reference in its entirety into this application.

### BACKGROUND OF THE INVENTION

1. Field of the Invention

The present invention relates to a display device using a single-panel diffractive light modulator. In particular, the present invention relates to a display device using a single-panel diffractive light modulator, in which a filter unit is disposed at a location sufficiently far away from the diffractive light modulator, so that the filter unit can be constructed without using a Fourier lens, thereby enabling a reduction in size and cost.

2. Description of the Related Art

Among display devices, small-sized display devices are display devices that have small sizes and low power consumption. Such small-sized display devices are particularly useful as displays for mobile terminals.

Spatial Light Modulators (SLMs) are devices that are particularly efficient in forming images in such small-sized display devices. “SLMs” refers to devices that display images by modulating incident light. Using SLMs, incident light may be modulated in phase, intensity, polarization or direction.

Among such SLMs, a “diffractive light modulator” refers to a device that generates diffracted light by modulating incident light and forms images using the diffracted light. An example of a display device using such a diffractive light modulator is illustrated in FIG. 1.

FIG. 1 is a diagram showing the construction of a prior art display device using a single-panel diffractive light modulator.

Referring to FIG. 1, the prior art display device using a single-panel diffractive light modulator includes a light source unit 10, a condensing unit 12, an illumination unit 14, a diffractive light modulator 18, a Fourier filter unit 20, a projection unit 24, and a screen 28.

The light source unit 10 includes a plurality of light sources 11a˜11c. In one application thereof, the light sources 11a˜11c may be sequentially lit. The condensing unit 12 includes a mirror 13a and a plurality of dichroic mirrors 13b and 13c, and functions to cause light from the plurality of light sources to have a single light path by combining the light from the plurality of light sources 11a˜11c.

The illumination unit 14 converts light, passed through the condensing unit 12, into linear collimated light, and causes the linear collimated light to be incident on the diffractive light modulator 18. The diffractive light modulator 18 creates linear diffracted light having a plurality of diffraction orders by modulating the incident light, and emits the linear diffracted light. In this case, diffracted light, which has a given diffraction order and is desired to be used in an application, is formed to vary in light intensity at respective locations thereof so that it forms images on the screen 28. That is, since the diffracted light created in the diffractive light modulator 18 is linear and the linear diffracted light may have different light intensity values at respective locations thereof, two-dimensional (2D) images can be formed when the diffracted light is scanned over the screen 28.

Meanwhile, the diffracted light generated by the diffractive light modulator 18 enters the Fourier filter unit 20. The Fourier filter unit 20 includes a Fourier lens 21 and a dichroic filter 22, and functions to separate the diffracted light according to diffraction order and to pass only diffracted light having a desired diffraction order therethrough.

Meanwhile, the projection unit 24 includes a projection lens 25 and a scanner 26. The projection lens 25 expands the incident diffracted light, while the scanner 26 creates images by projecting the incident diffracted light onto the screen 28.

Meanwhile, the above-described Fourier filter unit 20 uses the fact that the diffracted light generated by the diffractive light modulator 18 departs from the diffractive light modulator 18 at different angles depending on the diffraction order. That is, light emitted from the diffractive light modulator 18 is diffracted at different angles depending on the diffraction order. Typically, 0th-order diffracted light or 1st-order diffracted light is used to generate displayed images. When the 0th-order diffracted light, which is brightest, is used, brightness is increased, but noise is also increased. In contrast, when 1st-order diffracted light is used, brightness is lower than in the case of 0th-order diffracted light, but noise is also decreased, with the result that clear images can be realized.

The Fourier filter unit 20 may be disposed at a location, for example, at the location of a pupil, in a display device such that it can separate diffracted light having a desired diffraction order from diffracted light having a plurality of diffraction orders. This allows diffracted light having undesired diffraction orders to be blocked by the Fourier filter unit 20, and allows diffracted light having a desired diffraction order to pass through the Fourier filter unit 20 and to realize displayed images.

In order to block diffracted light having undesired diffraction orders and pass only diffracted light having a desired diffraction order therethrough, the Fourier filter unit 20 needs to definitely separate diffracted light according to diffraction order.

For this purpose, the Fourier filter unit 20 includes the Fourier lens 21. The Fourier lens 21 clearly separates the diffracted light having a plurality of diffraction orders, which is emitted from the diffractive light modulator 18, according to diffraction order.

As described above, there is difficulty in manufacturing small-sized products because there is a restriction in that the Fourier filter unit 20 must be located in a pupil in the display device using a single-panel diffractive light modulator, and in that the Fourier lens is dispensable to increase separation angles according to diffraction angles.

The difficulty with the reduction in the size of products is further undesirable in consideration of the application of the display device using a single-panel diffractive light modulator to portable terminals and the users' requirement for a reduction in the size of the portable terminals.

### SUMMARY OF THE INVENTION

Accordingly, the present invention has been made keeping in mind the above problems occurring in the prior art, and an object of the present invention is to provide a display device using a single-panel diffractive light modulator, in which a filter unit is disposed at a location sufficiently far away from the diffractive light modulator, so that a filter unit can be constructed without requiring a Fourier lens, thereby enabling a reduction in the size of products.

In order to accomplish the above object, the present invention provides a display device using a single-panel diffractive light modulator, including a light source unit comprising a plurality of light sources for respectively emitting beams of light having respective wavelengths; a condensing unit for causing the beams of light, emitted from the plurality of light sources, to have an identical light path; an illumination unit for converting the light, emitted from the light sources of the light source unit, into linear light; a diffractive light modulator for generating diffracted light having a plurality of diffraction orders by modulating the linear light when the linear light enters from the illumination unit, so that diffracted light having at least one diffraction order, which will be used in an application, has light intensity values suitable for the application at respective locations thereof; a projection unit for projecting the diffracted light having a plurality of diffraction orders, emitted from the diffractive light modulator, onto the screen and generating images; and a filter unit disposed between the projection unit and the screen, and configured to pass only the diffracted light having at least one desired diffraction order, which belongs to the diffracted light having a plurality of diffraction orders projected by the projection unit, therethrough.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a prior art display device using a single-panel diffractive light modulator;

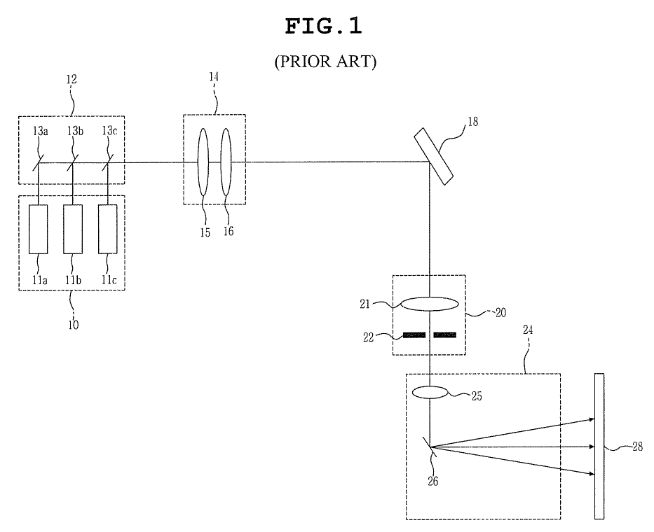

FIG. 2 is a diagram showing the construction of a display device using a single-panel diffractive light modulator according to an embodiment of the present invention;

FIG. 3 a diagram showing the construction of a display device using a single-panel diffractive light modulator according to another embodiment of the present invention;

FIG. 4 a diagram showing the construction of a display device using a single-panel diffractive light modulator according to still another embodiment of the present invention; and

FIG. 5 is a partial cutaway view showing a portable terminal in which the display device using a single-panel diffractive light modulator according to the embodiment of the present invention is installed.

### DESCRIPTION OF THE PREFERRED EMBODIMENTS

Reference now should be made to the drawings, in which the same reference numerals are used throughout the different drawings to designate the same or similar components.

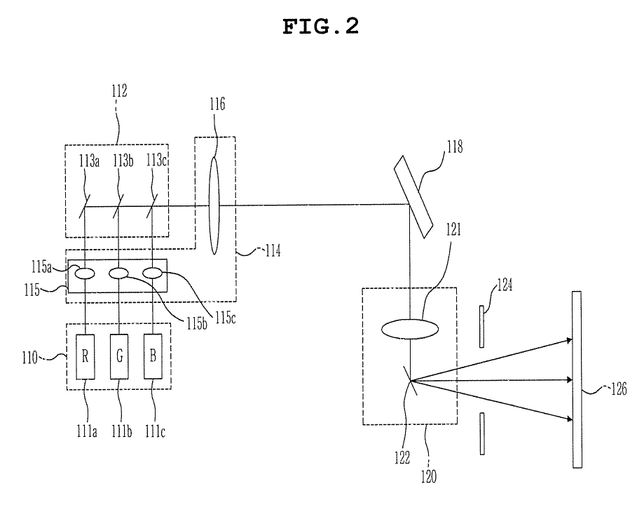

With reference to FIGS. 2 to 5, a display device using a single-panel diffractive light modulator according to the present invention is described in detail below.

FIG. 2 is a diagram illustrating the construction of a display device using a single-panel diffractive light modulator according to an embodiment of the present invention.

Referring to FIG. 2, the display device using a single-panel diffractive light modulator according to the embodiment of the present invention includes a light source unit 110 for generating and emitting a plurality of beams of light, a condensing unit 112 for causing the plurality of beams of light, emitted from the light source unit 110, to have the same light path, an illumination unit 114 for converting the light, emitted from the condensing unit 112, into linear collimated light and causing the linear collimated light to enter a diffractive light modulator 118, the diffractive light modulator 118 for generating diffracted light having a plurality of diffraction orders by diffracting the light incident from the illumination unit 114 and emitting the diffracted light so that diffracted light having at least one diffraction order, which belongs to diffracted light having a plurality of diffraction orders, can form a desired image, a projection unit 120 for projecting the diffracted light having a plurality of diffraction orders, generated by the diffractive light modulator 118, onto the screen 126, and a filter unit 124 located between the projection unit 120 and the screen 126 and configured to pass diffracted light having a desired diffraction order therethrough.

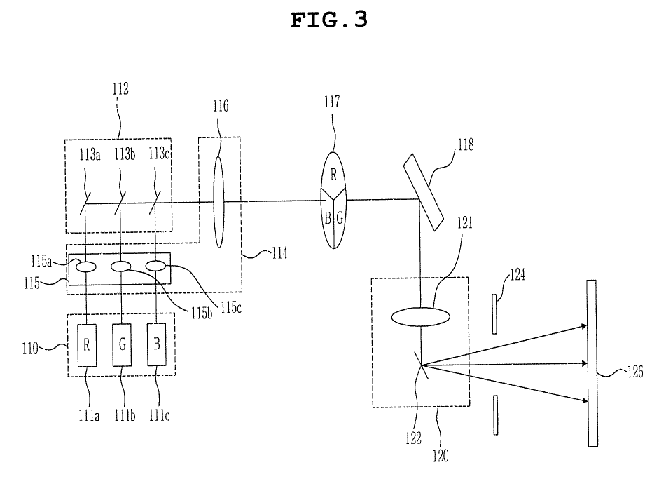

The light source unit 110 includes a plurality of light sources, for example, a red light source 111a, a green light source 111b, and a blue light source 111c. Laser diodes or light emitting diodes may be used as the respective light sources 111a, 111b and 111c. In this case, if the light source unit 110 emits red light, green light and blue light in a time division manner in the case where a single-panel type is used, as in the present embodiment of the present invention, that is, in the case where a single diffractive light modulator 118 is used, there is no need to provide a separate color wheel (a device capable of time-dividing a multiple beam according to the color) upstream or downstream of the diffractive light modulator 118. Of course, if the light source unit 110 emits a plurality of beams of light at the same time, that is, if the light source unit 110 emits the beams without time division, a separate color wheel 117 is provided upstream or downstream of the diffractive light modulator 118, as illustrated in FIG. 3, so that the plurality of beams of light does not enter the diffractive light modulator 118 simultaneously, but enters the diffractive light modulator 118 at different times.

The condensing unit 112 may include a plurality of reflecting mirrors and a plurality of dichroic mirrors. For example, the condensing unit 112, as shown in FIG. 2, includes a single reflecting mirror 113a and two dichroic mirrors 113b and 113c, and causes a plurality of beams of light, emitted from the plurality of light sources 111a, 111b and 111c, to have the same light path. That is, the reflecting mirror 113a locates red light on a desired light path by changing the path of light emitted from the red light source 111a, the dichroic mirror 113b, located downstream of the reflecting mirror 113a, passes the red light therethrough, reflects green light, emitted from the green light source 111b, so that the red light and the green light are located on the same light path, and the dichroic mirror 113c, located downstream of the dichroic mirror 113b, passes the red light and the green light therethrough and reflects blue light emitted from the blue light source 111c, so that the red light, the green light and the blue light are located on the same light path.

Meanwhile, the collimating lens unit 115 of the illumination unit 114 is located between the light source unit 110 and the condensing unit 112. Here, the collimating lens unit 115 includes a plurality of collimating lenses 115a, 115b and 115c, and the collimating lenses 115a, 115b and 115c are located to correspond to the respective light sources 111a, 111b, and 111c of the light source unit 110 and convert divergent light, emitted from the respective light sources 111a, 111b and 111c, into collimated light.

The cylinder lens 116 of the illumination unit 114 is located downstream of the condensing unit 112, and the cylinder lens 116 converts the collimated light, emitted from the condensing unit 112, into linear light, and causes the linear light to enter the diffractive light modulator 118.

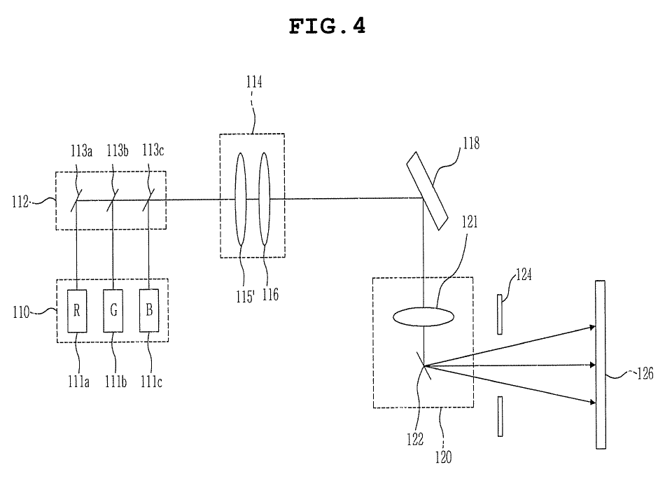

Although the embodiment of the present invention is constructed such that the collimating lens unit 115 of the illumination unit 114 is located between the light source unit 110 and the condensing unit 112 and the cylinder lens 116 is located downstream of the condensing unit 112, another embodiment, as illustrated in FIG. 4, may be constructed such that the collimating lens 115′ of the illumination unit 114 is located downstream of the condensing unit 112. By doing so, desired collimated light can be generated using only a single collimating lens 115′, compared to the case where collimated light is generated using the collimating lens unit 115 composed of the three collimating lenses 115a, 115b and 115c, as shown in FIG. 2. Accordingly, this results in a reduction in cost.

Thereafter, when linear collimated light enters from the illumination unit 114, the diffractive light modulator 118 generates diffracted light having a plurality of diffraction orders by performing light modulation and emits the diffracted light. Here, the diffracted light having a plurality of diffraction orders, emitted from the diffractive light modulator 118, is linear light from the point of view of respective diffraction orders.

Furthermore, diffracted light having a desired diffraction order, which belongs to the diffracted light having a plurality of diffraction orders emitted from the diffractive light modulator 118, and which is desired to be projected onto the screen 126 in order to form images, may be constructed to vary in light intensity at respective locations thereof, so that desired images can be formed by projecting the diffracted light having the corresponding diffraction order onto the screen 126.

Furthermore, the diffracted light having a plurality of diffraction orders, emitted from the diffractive light modulator 118, propagates at different diffraction angles. Accordingly, the shortest distance between beams of light increases in proportion to the distance from the beams of light to the diffractive light modulator 118.

As a result, as in the embodiment of the present invention, when the filter unit 124 is located downstream of the projection unit 120, the filter unit 124 is located sufficiently far away from the diffractive light modulator 118. Accordingly, the diffracted light having a plurality of diffraction orders, emitted from the filter unit 124, enters with the shortest distance sufficiently ensured between the beams of diffracted light, therefore a Fourier lens is not required to increase the shortest distance.

That is, in the prior art, the filter unit 124 is located downstream of the diffractive light modulator 118, so that diffracted light having a plurality of diffraction orders enters the filter unit 124 with the shortest distance between beams of light having respective diffraction orders not sufficiently ensured. Accordingly, the prior art is configured such that the Fourier lens is further included, and passes only diffracted light having a desired diffraction order therethrough after the shortest distance between the beams of light has been sufficiently ensured. In contrast, in the present invention, after diffracted light having a plurality of diffraction orders, emitted from the diffractive light modulator 118, has propagated sufficiently, and thus the beams of the diffracted light have been somewhat separated from each other, diffracted light having a desired diffraction order is separated from diffracted light having a plurality of diffraction orders. Consequently, the Fourier lens is not required in order to separate the diffracted light having a desired diffraction from the diffracted light having a plurality of diffraction orders.

Meanwhile, the projection unit 120 includes a projection lens 121 and a scanner 122, and expands the linear diffracted light emitted from the diffractive light modulator 118, and scans the expanded diffracted light across the screen 126, thereby generating 2D images.

The projection lens 121 of the projection unit 120 expands the diffracted light having a plurality of diffraction orders emitted from the diffractive light modulator 118, and thus the shortest distance between the beams of diffracted light having respective diffraction orders is further increased. That is, in the present invention, the projection lens 121 of the projection unit 120 functions to expand the diffracted light emitted from the diffractive light modulator 118, and also functions to separate beams of light having respective diffraction orders, thus functioning as a Fourier lens.

The scanner 122 of the projection unit 120 scans the linear diffracted light having a plurality of diffraction orders, expanded through the projection lens 121, across the screen 126, thereby forming 2D images.

A Galvanometer mirror or a polygon mirror may be used as the scanner 122.

A slot or dichroic filter may be used as the filter unit 124. The filter unit 124 passes diffracted light having a desired diffraction order therethrough, and blocks diffracted light having undesired diffraction orders. Since the filter unit 124 does not require a Fourier lens, unlike the prior art filter unit, a reduction in size and cost can be achieved.

That is, in the present invention, since the filter unit 124 is located sufficiently far away from the diffractive light modulator 118, diffracted light having a plurality of diffraction orders enters the filter unit 124 with the shortest distance between beams of light having respective diffraction orders sufficiently ensured such that they can be separated using a slot or dichroic filter. Accordingly, the present invention does not require a Fourier lens, unlike the prior art. As a result, a reduction in the size and cost of products can be achieved.

Furthermore, the filter unit 124 of the present invention is located downstream of the projection unit 120, so that the filter unit 124 may be realized in the casing of a portable terminal in the case where a display device using a single-panel diffractive light modulator is installed in such a portable terminal, and the advantage of a reduction in size can be further increased.

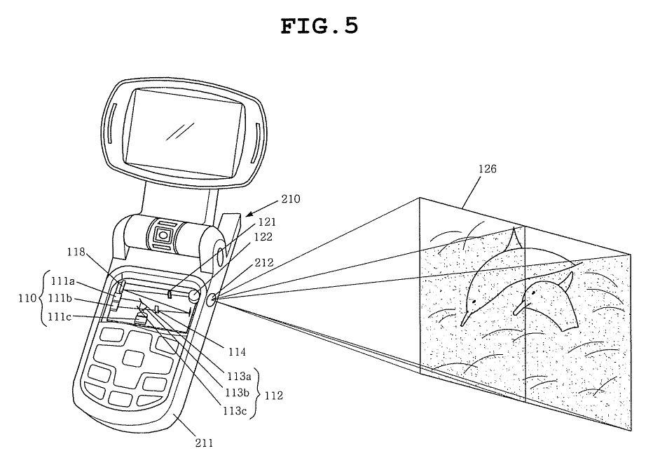

That is, when the opening 212 of the casing 211 is constructed in the form of a slot in the case where the display device using the single-panel diffractive light modulator is installed in a portable terminal 210, as shown in FIG. 5, the space that is occupied by the display device using the single-panel diffractive light modulator in the portable terminal 210 can be reduced, therefore a reduction in the size of a portable terminal can be achieved. Although, in FIG. 5, the construction of FIG. 4 is used as the construction of a display device using a single-panel diffractive light modulator, the construction of FIG. 2 or 3 may be used.

Meanwhile, the filter unit 124 may be implemented such that it is fixed regardless of the movement of the scanner 122, or such that the filter unit 124 moves in conjunction with the movement of the scanner 122 in some applications.

According to the present invention, the filter unit does not need to include a Fourier lens, therefore a reduction in size can be achieved.

Furthermore, according to the present invention, the filter unit does not need to include a Fourier lens, therefore a reduction in cost can be achieved.

Furthermore, according to the present invention, in the case where the display device using a single-panel diffractive light modulator is installed in a portable terminal, the filter unit can be realized in the casing of the portable terminal, therefore the advantage of a reduction in size can be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A display device using a single-panel diffractive light modulator, comprising:
a light source unit comprising a plurality of light sources for respectively emitting beams of light having respective wavelengths;
a condensing unit for causing the beams of light, emitted from the plurality of light sources, to have an identical light path;
an illumination unit for converting the light, emitted from the light sources of the light source unit, into linear light;
a diffractive light modulator for generating diffracted light having a plurality of diffraction orders by modulating the linear light when the linear light enters from the illumination unit, so that diffracted light having at least one diffraction order, which will be used in an application, has light intensity values suitable for the application at respective locations thereof;
a projection unit for projecting the diffracted light having a plurality of diffraction orders, emitted from the diffractive light modulator, onto the screen and generating images; and
a filter unit disposed between the projection unit and the screen, and configured to pass only the diffracted light having at least one desired diffraction order, which belongs to the diffracted light having a plurality of diffraction orders projected by the projection unit, therethrough.

2. The display device as set forth in claim 1, wherein the projection unit comprises:
a projection lens for expanding the diffracted light having a plurality of diffraction orders, emitted from the diffractive light modulator; and
a scanner for scanning the diffracted light, entering from the projection lens, across a screen.

3. The display device as set forth in claim 2, wherein the scanner is a Galvanometer mirror.

4. The display device as set forth in claim 2, wherein the scanner is a polygon mirror.

5. The display device as set forth in claim 1, wherein the filter unit is a slot that is disposed between the projection unit and the screen and passes diffracted light having at least one desired diffraction order, selected from the diffracted light having a plurality of diffraction orders projected by the projection unit, therethrough.

6. The display device as set forth in claim 1, wherein the filter unit is a dichroic filter that is disposed between the projection unit and the screen and passes diffracted light having at least one desired diffraction order, selected from the diffracted light having a plurality of diffraction orders projected by the projection unit, therethrough.

7. The display device as set forth in claim 1, wherein the filter unit is located in a light emission hole of a casing of a portable terminal when the display device using the single-panel diffractive light modulator is installed in the portable terminal and the screen is located outside the portable terminal.
